(19) United States
(12) Patent Application Publication
(10) Pub. No.: US 2026/0229078 A1
(43) Pub. Date: Aug. 6, 2026

(54) Method for Documenting Controlled Substance Wasting at Controlled Substance Storage Vault

(71) Applicant: CompX International Inc., Greenville, SC (US)

(72) Inventors: Mitchell S. Mlynarczyk, Wauconda, IL (US); Kenneth A. Kaczmarz, Bristol, WI (US); Mike Jensen, Salem, WI (US); Aaron M. McMahon, McHenry, IL (US)

(21) Appl. No.: 19/464,727

(22) Filed: Jan. 30, 2026

Related U.S. Application Data
(60) Provisional application No. 63/754,631, filed on Feb. 6, 2025.

(51) Int. Cl. G07C 9/00; G06K 17/00; G06K 19/07; G07C 9/25

(52) U.S. Cl. CPC G07C 9/00912; G06K 17/0029; G06K 19/0723; G07C 9/25

(57) ABSTRACT

The present disclosure relates to presently disclosed improvements regarding methodology for documenting controlled substance wasting at controlled substance storage vault, including for some embodiments leveraging use of currently available RFID enabled controlled substance vault technology. The process of disposing of controlled substances is referred to as “wasting.” When a controlled substance is wasted the following information must be documented 1) person who performed the wasting, 2) a separate person who witnessed the wasting, 3) amount of controlled substance that was administered, 4) amount of controlled substance that was wasted, 5) reason that the controlled substance was wasted, and 6) date and time of the wasting. The presently disclosed subject matter provides technology for guiding users (such as paramedics) through a process for capturing required wasting data.

### PRIORITY CLAIM

The present application claims the benefit of priority of U.S. Provisional Patent Application No. 63/754,631, titled Method for Documenting Controlled Substance Wasting at Controlled Substance Storage Vault, filed February 6, 2025, and which is fully incorporated herein by reference for all purposes.

### BACKGROUND OF THE PRESENTLY DISCLOSED SUBJECT MATTER

The present disclosure relates to improvements to currently available controlled substance storage vaults. Many of these vaults are provided with access control systems which limit the access to a select group of people. One such access controlled vault is provided with a system for inventory control provided with RFID technology. Complete technology associated with such vault is fully described in US patents US11373078, US11301741, and US11176765.

The presently disclosed improvements pertain to federally mandated documentation of the portion of the controlled substance that is not administered to a patient. The process of disposing of controlled substances is referred to as “wasting.” When a controlled substance is wasted the following information must be documented 1) person who performed the wasting, 2) a separate person who witnessed the wasting, 3) amount of controlled substance that was administered, 4) amount of controlled substance that was wasted, 5) reason that the controlled substance was wasted, and 6) date and time of the wasting.

Currently, personnel involved in the wasting process must, at a later time, document the aforementioned information. Currently available controlled substance inventory systems do not adequately document wasting as an integral feature of the software. Further, there are no commercially available systems that will allow the personnel that wasted the controlled substance to immediately properly document wasting at the time of use in the field.

### SUMMARY OF THE PRESENTLY DISCLOSED SUBJECT MATTER

The presently disclosed subject matter relates to systems and apparatuses and corresponding and/or associated methodology. For example, presently disclosed improvements relate to methodology for documenting controlled substance wasting at controlled substance storage vault, including for some embodiments leveraging use of currently available RFID enabled controlled substance vault technology. As will be understood from those of ordinary skill in the art, the presently disclosed methodology can be readily adapted for use with embodiments comprising non-inventory controlled systems as well.

The access control system, RFID technology, communication technology, database technology, and tamper evident storage used for some presently disclosed embodiments are represented, for example, in the aforementioned patents, as well as US8970344, US8742889, US8199019, and US7768378. Such patents include further features which are not required for practicing the presently disclosed subject matter, and may be omitted by those skilled in the art, to remove any unused or unnecessary feature sets in a given embodiment of the presently disclosed subject matter. The complete disclosures of all US patents referenced in the subject application are fully incorporated by reference into such application and for all purposes.

One exemplary embodiment of presently disclosed subject matter may relate to a system for controlled substance storage and automated wasting documentation. Such system may preferably comprise a closable enclosure having a securable interior portion; an electronically actuated lock system for selectively allowing and inhibiting access to such securable interior portion; a plurality of medicinal units received within such securable interior portion, each unit associated with a respective tamper-evident RFID tag having an ID characteristic; an RFID reading system associated with such enclosure and adapted for identifying such medicinal units by reading such ID characteristics; a microprocessor-based access control circuit operatively connected to such lock system and such RFID reading system; and a user interface configured to provide a user access to such access control circuit; wherein such microprocessor-based access control circuit is programmed for detecting removal of a specific medicinal unit via a change in the status of its associated RFID tag and, upon detecting such removal, to guide a user via such user interface through a mandatory wasting documentation sequence if all contents of the specific medicinal unit are not administered to a patient.

It is to be understood that the presently disclosed subject matter equally relates to associated and/or corresponding methodologies.

Other example aspects of the present disclosure are directed to systems, apparatus, tangible, non-transitory computer-readable media, user interfaces, memory devices, and electronic devices for integrated electronic lock control. To implement methodology and technology herewith, one or more processors may be provided, programmed to perform the steps and functions as called for by the presently disclosed subject matter, as will be understood by those of ordinary skill in the art.

Another exemplary embodiment of presently disclosed subject matter may relate to methodology for documenting controlled substance wasting at a secure storage vault. Such methodology may preferably comprise providing a closable enclosure having a securable interior portion with an electronically actuated lock system for selectively allowing and inhibiting access to such securable interior portion; providing a plurality of medicinal units to be received within such securable interior portion, each unit associated with a respective tamper-evident RFID tag having an ID characteristic; associating an RFID reading system with such enclosure for identifying specific tagged medicinal units therein; validating credentials of a first user to unlock such enclosure via the lock system; detecting the removal of at least one specific tagged medicinal unit from such enclosure by monitoring the status of its associated RFID tag with the RFID reading system; and initiating an automated wasting documentation sequence via a user interface associated with such enclosure to capture wasting data related to the specific medicinal unit identified if all contents of the specific medicinal unit are not administered to a patient.

Yet another presently disclosed exemplary embodiment may relate to methodology for documenting controlled substance wasting at a secure storage vault. Such methodology may preferably comprise providing a closable enclosure with an electronically actuated lock system for selectively allowing and inhibiting access to such closable enclosure; providing a plurality of medicinal units to be received within such closable enclosure; validating credentials of a first user to unlock such closable enclosure via the lock system; detecting the removal of at least one specific tagged medicinal unit from such closable enclosure; and initiating an automated wasting documentation sequence via a user interface associated with such enclosure to capture wasting data related to the specific medicinal unit detected as removed if all contents of the specific medicinal unit are not administered to a patient, wherein the mandatory wasting documentation sequence requires the input of (i) identification of a first user performing a wasting process; (ii) identification of a separate second user witnessing such wasting process; (iii) a value representing an amount of the controlled substance administered; (iv) a value representing an amount of the controlled substance wasted; and (v) a selection of a reason for the wasting of such controlled substance.

Additional objects and advantages of the presently disclosed subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments, uses, and practices of the presently disclosed subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the presently disclosed subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the presently disclosed subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification, and will appreciate that the presently disclosed subject matter applies equally to corresponding methodologies as associated with practice of any of the present exemplary devices, and vice versa.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 illustrates a representative flowchart of a presently disclosed exemplary embodiment of presently disclosed methodology;

FIGS. 2(a) through 5(b) illustrate respective views of exemplary representative screen interactions involving a user (for example, paramedic) practicing the exemplary methodology of present FIG. 1; and

FIGS. 6(a), 6(b), and FIG. 6(c) represent exemplary views of screens illustrating software presentation of associated data in accordance with presently disclosed subject matter.

Repeat use of reference characters in the present specification and drawings is intended to represent the same or analogous features, elements, or steps of the presently disclosed subject matter.

### DETAILED DESCRIPTION OF THE PRESENTLY DISCLOSED SUBJECT MATTER

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

As used herein, the term “or” is inclusive unless stated otherwise. For instance, if a computer requires A or B to be true in order to perform operation C, the case of both A and B being true will satisfy the condition necessary for C to occur. That is, “or” is inclusive of A, B, and A and B.

In general, the present disclosure is directed to systems, apparatuses, and associated methodologies for documenting controlled substance wasting at controlled substance storage vaults.

As described in exemplary US patent US11373078, a summarized current typical interaction between the user administering a controlled substance (for example, paramedic) and the vault is as noted herein. It should be understood that the state in which this summary begins is a vault securely enclosing many known controlled substances (and their corresponding RFID tags). The typical method is:

1) Vault is secure holding many controlled substances.

2) Paramedic presents unique access control credential to the vault electronics, as is well understood by those of ordinary skill in the art without the need for additional detailed description herein.

3) If paramedic’s credential is known by the vault electronics to be valid, an electronic locking system will open the door to the vault. Again, such subject matter involving many different types of electronic locking systems are well known to those of ordinary skill in the art without further discussion herein, and form no particular part of the presently disclosed subject matter.

4) The paramedic opens the vault door, removes a controlled substance and closes the vault door.

5) The vault senses the door is closed and begins a process to scan the RFID tags corresponding to the controlled substances remaining in the vault.

6) The vault is able to determine which controlled substance has been removed by comparing the new inventory with the inventory that was known before the paramedic presented their credential.

7) After the missing controlled substance has been identified, the vault notifies the paramedic of the missing controlled substance. The vault then inquires regarding the whereabouts of the missing controlled substance.

8) If the paramedic tells the vault that the drug was administered, the vault (if properly configured) will then ask the paramedic to identify an incident number for later reporting and audit.

Once the paramedic has identified that the controlled substance has been administered and the incident number has been noted, there may exist a need for the paramedic to waste the remaining controlled substance on site. Currently there is no method to immediately document this process.

With the presently disclosed wasting process enabled, the representative exemplary vault system will continue to question the paramedic with the following new steps.

9) The vault will then ask the paramedic if they want to document the wasting.

10) If the paramedic chooses to document the wasting, the vault will then ask the paramedic the reason the controlled substance was wasted, the units of measure for this controlled substance, the amount administered, and the amount wasted.

11) The paramedic will then be asked for a witness to the wasting. This witness feature is programmable (by a system administrator) to be required or optional.

12) The witness then presents their unique credential to the vault for later retrieval and audit. This witness must be different from the original paramedic who wasted the drug. Further, this witness must also have valid access to the vault. The information regarding the witness will be already loaded into the software system as they are a valid user at the vault.

After this transaction has occurred the vault will communicate with the database system using one of the secure communication methods and database structures noted in the aforementioned US patents. Such information can then be viewed and audited at a later date.

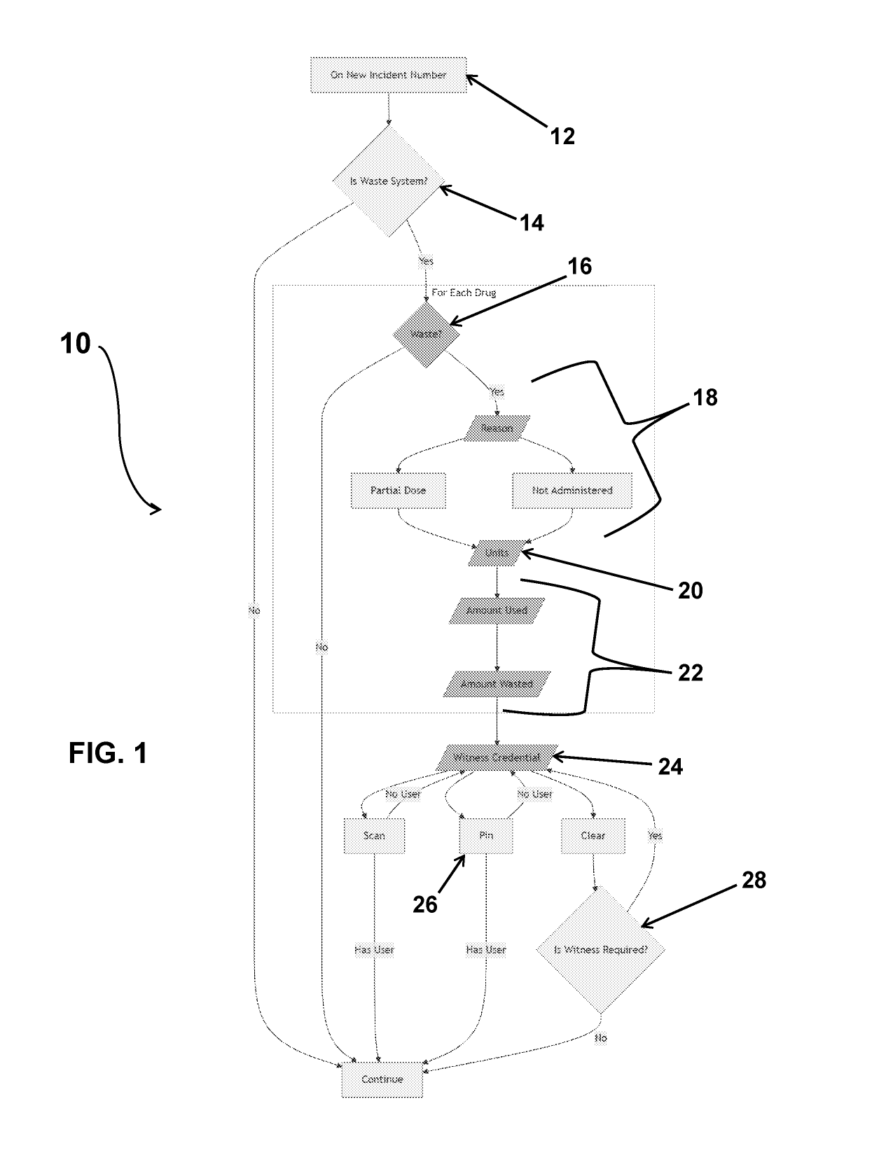

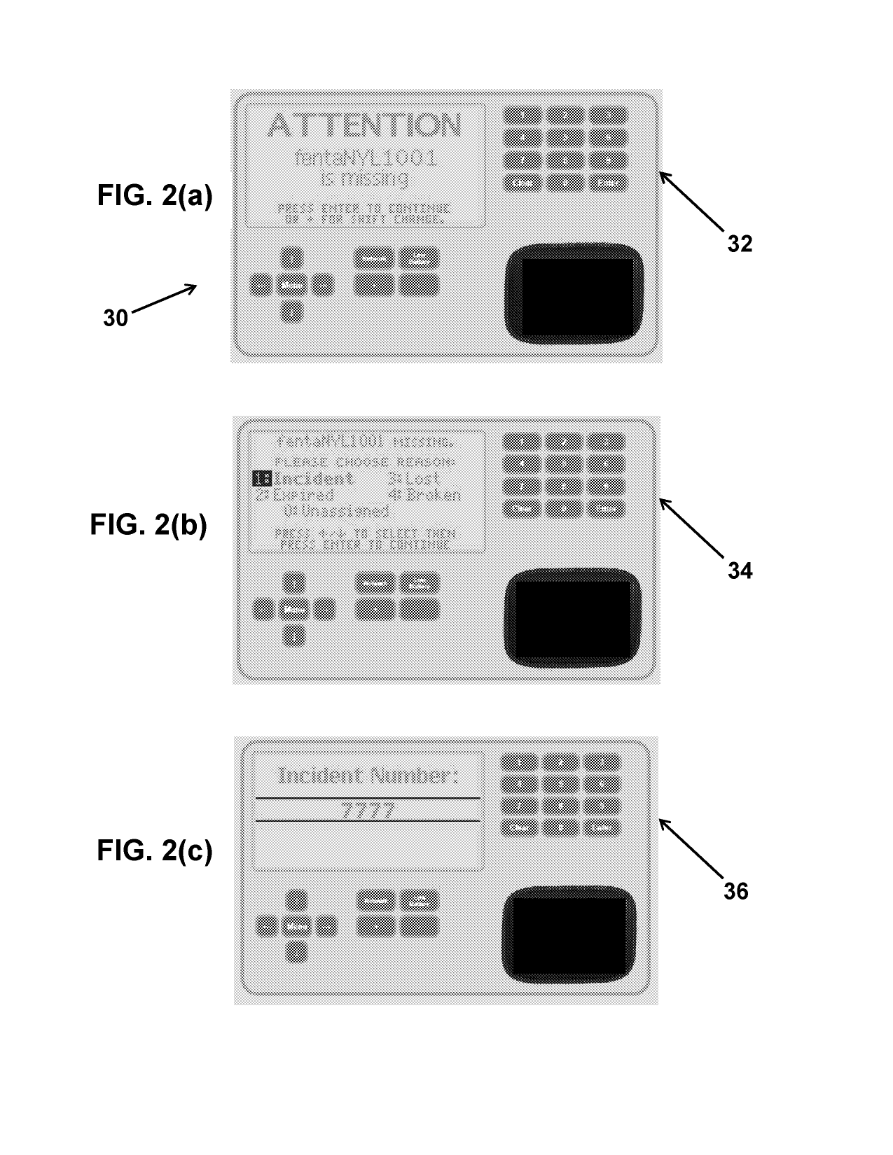

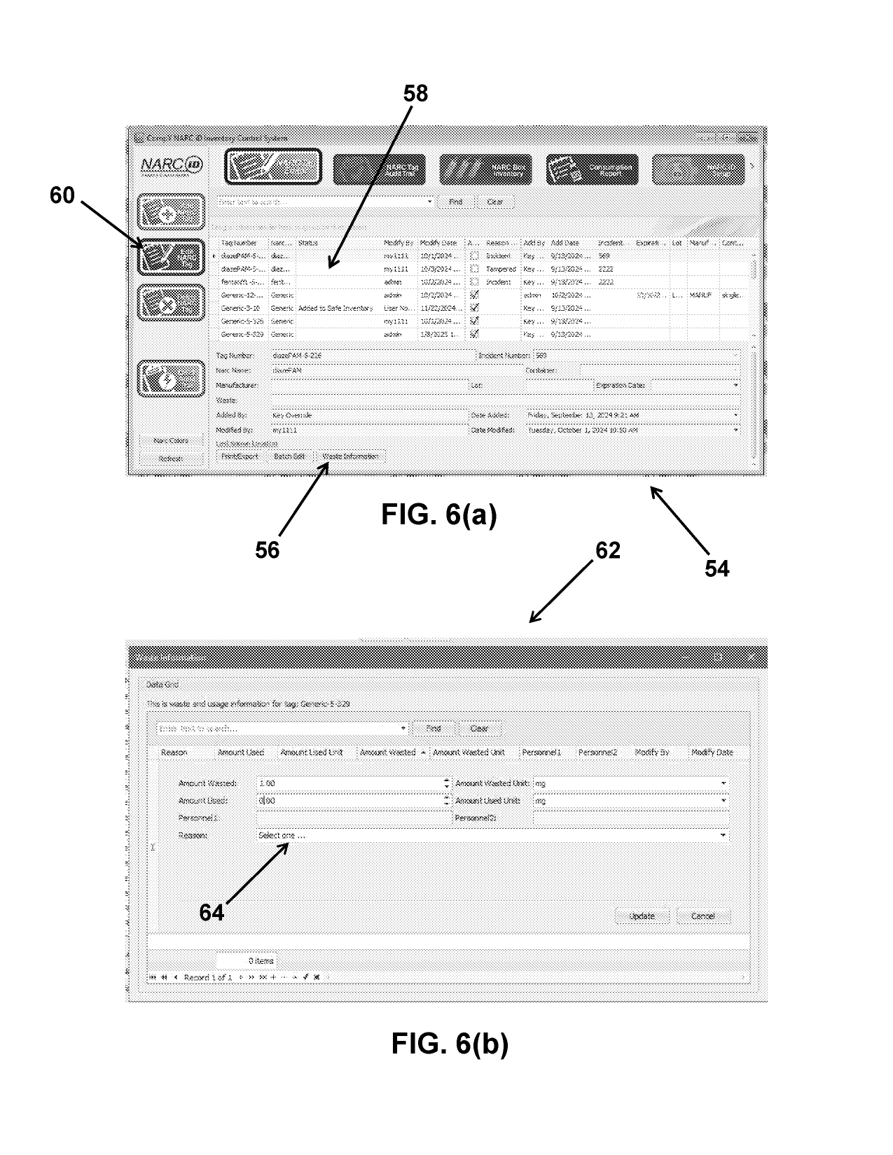

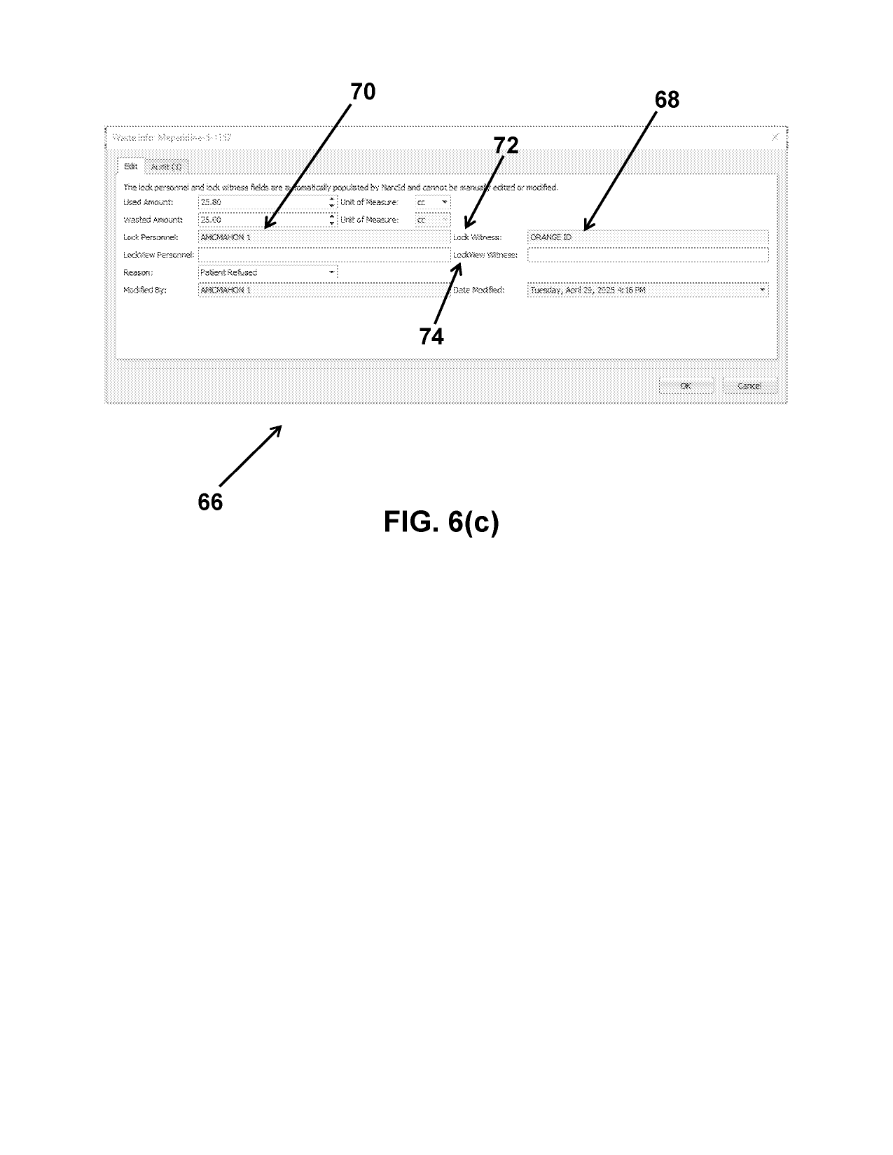

Such exemplary process is further detailed in the accompanying FIGS. 1 through 6(b), as follows. An exemplary representation of the presently disclosed process/method is noted in flowchart form in FIG. 1, while exemplary exact screen interactions between the vault and the paramedic are noted in FIGS. 2(a) through 5(b) while the software presentation of the associated data is shown in FIGS. 6(a) and 6(b). Such representative figures are one exemplary preferred embodiment but those skilled in the art could easily present the interaction in different order, different words or a different final presentation.

For brevity’s sake, the discussion will begin when the exemplary representative vault has determined that a controlled substance (actually the controlled substance’s RFID tag) is missing (as optionally represented on a screen 30 or similar output) at step 32 of FIG. 2(a). In such case, the exemplary vault has noticed that fentanyl 1001 is missing and is notifying the paramedic of such. The paramedic acknowledges this missing controlled substance by pressing enter and the vault then progresses to step 34, as represented by FIG. 2(b). At such step, the paramedic (user) can choose incident, expired, lost, or broken as possible reasons for the missing controlled substance. In the presently disclosed example, the paramedic chooses incident and the vault proceeds to the next step shown at step 36 per the illustration of FIG. 2(c). In such exemplary case, the paramedic entered incident number 7777. This step is noted in the flowchart 10 in FIG. 1 at step 12. If the wasting system is enabled, the vault will proceed to inquire about wasting at step 14.

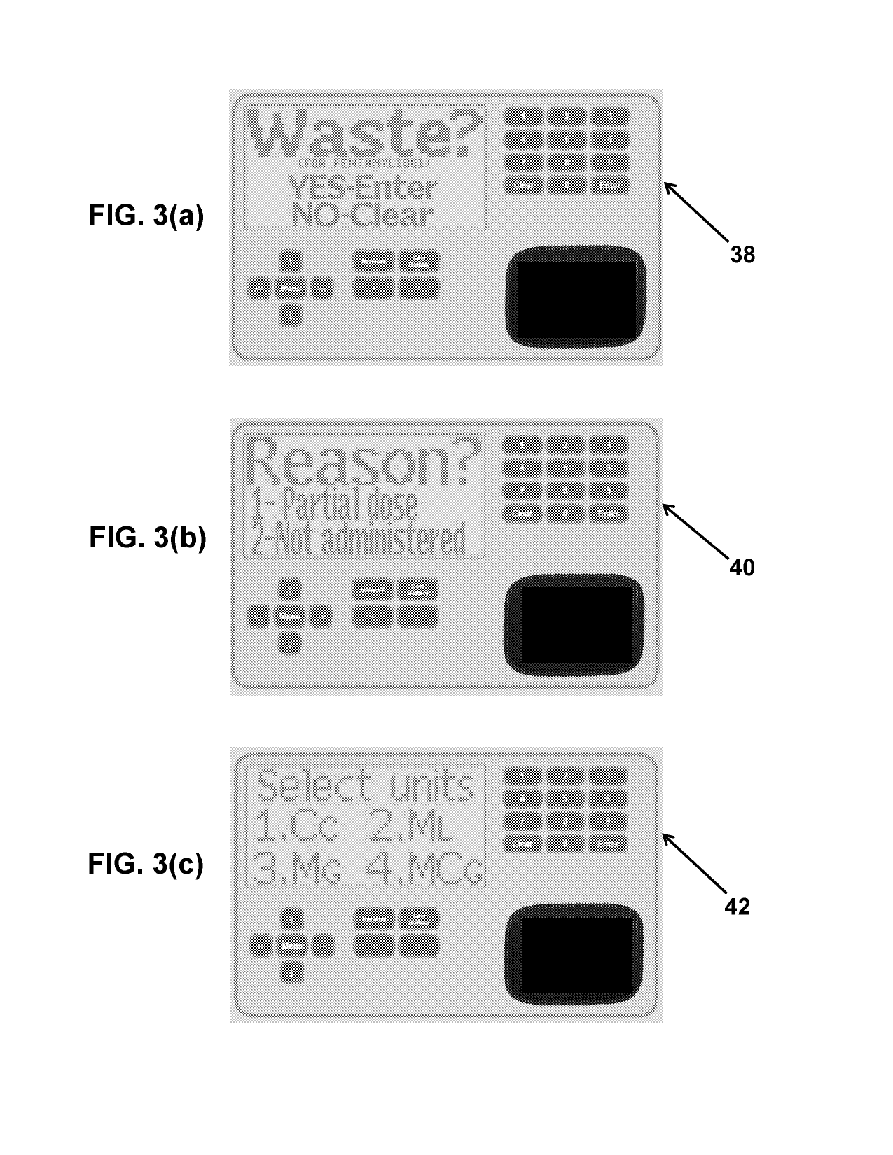

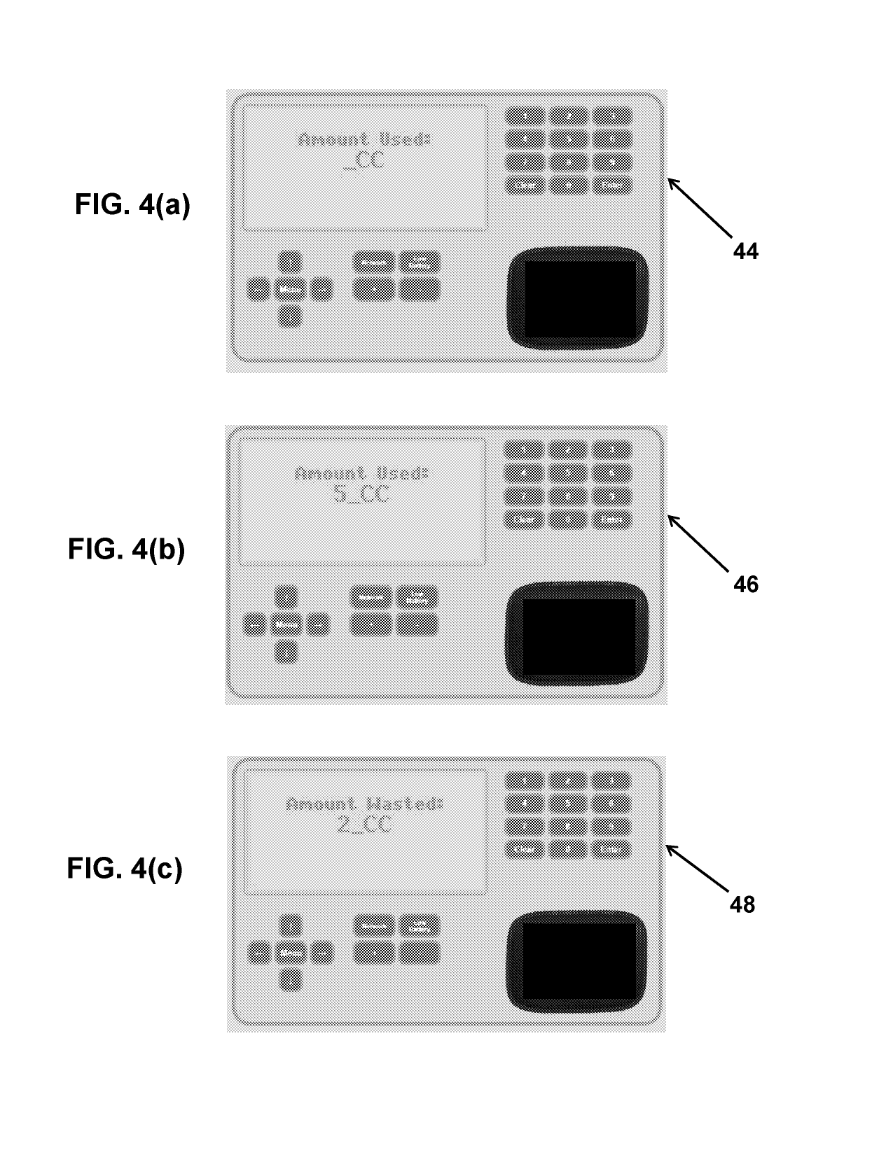

Turning now to FIGS. 3(a) through 3(c), the vault asks the paramedic if they are going to document wasting at screen 38 (FIG. 3(a) and step 16 in the flowchart 10 of FIG. 1). The paramedic enters yes by pressing enter. The vault then asks for a reason for wasting at screen step 40 (FIG. 3(b) and step 18 in the flowchart 10 of FIG. 1). The preferred system offers “partial dose” and “not administered” as options, but many other options are possible. The paramedic chooses one of these options and the vault then moves to screen step 42 (FIG. 3(c) and step 20 in the flowchart 10 of FIG. 1). The vault now asks the paramedic to document the amount of controlled substance that was used and amount wasted. The units available are cc (cubic centimeter), ml (milliliter), mg (milligram) and mcg (microgram). Many other units could be chosen by those skilled in the art. The paramedic chooses the preferred units and the vault then asks the paramedic how much was used at FIG. 4(a) step 44 and FIG. 4(b) step 46, and wasted at FIG. 4(c) step 48 (shown collectively as item 22 in the flowchart 10 of FIG. 1).

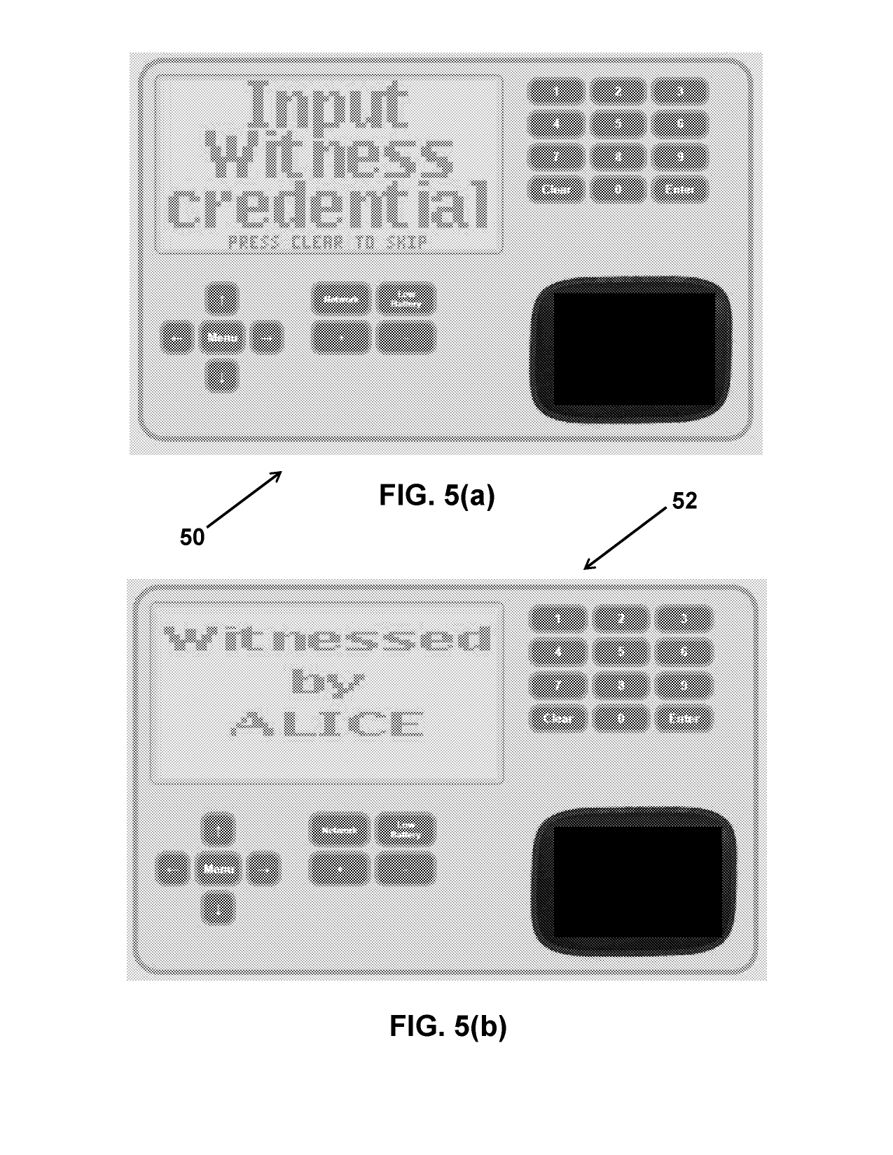

Finally, the vault moves to FIG. 5(a) step 50 (step 24 in the flowchart 10 of FIG. 1) and asks for the witness credential to be presented per FIG. 5(b) step 52 (step 26 in the flowchart 10 of FIG. 1). Such witnessing requirement is programmable on/off by a system administrator and (if not required) can be by-passed by pressing clear, shown in step 28 of the flowchart 10 of FIG. 1. If the witness is required, the vault will continue to ask for a valid witness until this requirement is met. Also, what qualifies as a valid witness may vary at different installations, depending on the practices or regulations applicable in a particular environment or jurisdiction. For example, a valid witness in some circumstances might require a person different than the primary use of the secure storage, and who personally observed such primary user waste the controlled substance. In some instances, the presented credentials may inherently speak to such requirements, or the substantiating validity of the witness may be otherwise documented.

If witnessing is not required and the paramedic chooses to not witness, the system can be configured to notify supervisory personnel of the non-witnessing situation. Such notification can be performed, for example, as described in patent US8742889. This system can send email, text message, or voice phone call to a programmable list of supervisory personnel who might be interested in the non-witnessed wasting. Those skilled in the art could notify in alternate methods as well.

The above process can be completed multiple times if multiple controlled substances are to be wasted. On a periodic basis, the exemplary vault will communicate with the main database using one of the secure methods identified in the aforementioned patents. Those skilled in the art will be able to use other secure communication methods as well.

Once the wasting information is loaded into the database, the database viewing program can be used to audit the information. An example of the interface screens are shown in FIGS. 6(a), 6(b), and FIG. 6(c). In particular, the software operator can see all of the general information on every controlled substance in screen 54 of FIG. 6(a), specifically area 58. Typically, the operator will select the controlled substance to be viewed and click the “edit narc tag” button 60, then click the “waste information” button 56. Once waste information has been pressed, the operator can view and edit the specific wasting information noted above (for example, reason, amount used, amount wasted, units, personnel performing the wasting, and witness to the wasting) as shown in FIG. 6(b) per screen 62 at area 64 thereof. The FIG. 6(c) interface screen 66 clearly shows differentiation between Witness 68 and Personnel (i.e., non-witness) 70, as well as the manner of entry (via the “Lock” 72 or via the supporting and/or associated software, i.e., “LockView” 74).

This written description uses examples to disclose the presently disclosed subject matter, including the best mode, and also to enable any person skilled in the art to practice the presently disclosed subject matter, including making and using any devices or systems and performing any incorporated methods. The patentable scope of the presently disclosed subject matter is defined by the claims, and may include other examples that occur to those skilled in the art. Such other examples are intended to be within the scope of the claims if they include structural and/or step elements that do not differ from the literal language of the claims, or if they include equivalent structural and/or elements with insubstantial differences from the literal languages of the claims. In any event, while certain embodiments of the disclosed subject matter have been described using specific terms, such description is for illustrative purposes only, and it is to be understood that changes and variations may be made without departing from the spirit or scope of the subject matter. Also, for purposes of the present disclosure, the terms "a" or "an" entity or object refers to one or more of such entity or object. Accordingly, the terms "a", "an", "one or more," and "at least one" can be used interchangeably herein.

What is claimed is:

1. A system for controlled substance storage and automated wasting documentation, comprising:
a closable enclosure having a securable interior portion;
an electronically actuated lock system for selectively allowing and inhibiting access to said securable interior portion;
a plurality of medicinal units received within said securable interior portion, each unit associated with a respective tamper-evident RFID tag having an ID characteristic;
an RFID reading system associated with said enclosure and adapted for identifying said medicinal units by reading said ID characteristics;
a microprocessor-based access control circuit operatively connected to said lock system and said RFID reading system; and
a user interface configured to provide a user access to said access control circuit;
wherein said microprocessor-based access control circuit is programmed for detecting removal of a specific medicinal unit via a change in the status of its associated RFID tag and, upon detecting said removal, to guide a user via said user interface through a mandatory wasting documentation sequence if all contents of the specific medicinal unit are not administered to a patient.

2. The system according to claim 1, wherein the mandatory wasting documentation sequence requires the input of:
(i) identification of a first user performing a wasting process;
(ii) identification of a separate second user witnessing said wasting process;
(iii) a value representing an amount of the controlled substance administered;
(iv) a value representing an amount of the controlled substance wasted; and
(v) a selection of a reason for the wasting of said controlled substance.

3. The system according to claim 1, wherein said microprocessor-based access control circuit is further programmed to automatically record a timestamp including the date and time of said wasting documentation sequence in a memory to establish a chain of custody for the specific medicinal unit identified by the RFID reading system.

4. The system according to claim 2, wherein identifying said separate second user requires during the wasting documentation sequence the presentation of a valid access credential by said second user to a reader associated with said electronically actuated lock system.

5. The system according to claim 4, wherein said valid access credential of said second user comprises a biometric credential.

6. The system according to claim 1, wherein said change in the status of the associated RFID tag comprises an altered ID characteristic produced by a frangible component of the RFID tag being ruptured.

7. The system according to claim 1, wherein said microprocessor-based access control circuit is further programmed to prevent subsequent access to the securable interior portion by the first user until the wasting documentation sequence for the previously removed medicinal unit is completed.

8. The system according to claim 1, further comprising:
a communications module for uploading data from said wasting documentation sequence to a central server over a network; and
wherein said closable enclosure includes electromagnetic shielding to block external electromagnetic fields, limiting RFID reading system detection to RFID tags located within the enclosure when closed.

9. Methodology for documenting controlled substance wasting at a secure storage vault, comprising:
providing a closable enclosure having a securable interior portion with an electronically actuated lock system for selectively allowing and inhibiting access to said securable interior portion;
providing a plurality of medicinal units to be received within said securable interior portion, each unit associated with a respective tamper-evident RFID tag having an ID characteristic;
associating an RFID reading system with said enclosure for identifying specific tagged medicinal units therein;
validating credentials of a first user to unlock said enclosure via the lock system;
detecting the removal of at least one specific tagged medicinal unit from said enclosure by monitoring the status of its associated RFID tag with the RFID reading system; and
initiating an automated wasting documentation sequence via a user interface associated with said enclosure to capture wasting data related to the specific medicinal unit identified if all contents of the specific medicinal unit are not administered to a patient.

10. The methodology according to claim 9, wherein the wasting documentation sequence requires the input of:
(i) identification of a first user performing a wasting process;
(ii) identification of a separate second user witnessing said wasting process;
(iii) a value representing an amount of the controlled substance administered;
(iv) a value representing an amount of the controlled substance wasted; and
(v) a selection of a reason for the wasting of said controlled substance.

11. The methodology according to claim 10, wherein the wasting documentation sequence further requires the first user to initially confirm whether to proceed with or abort the wasting documentation sequence.

12. The methodology according to claim 10, wherein the selection of a reason further includes requiring the selection of a reason for the wasting documentation sequence from a preprogrammed list of options provided via the user interface.

13. The methodology according to claim 9, further including preventing subsequent unlocking of the enclosure by the first user until the automated wasting documentation sequence for the previously removed specific medicinal unit is finalized or otherwise aborted.

14. The methodology according to claim 10, wherein identifying said separate second user includes the second user presenting a valid electronic credential to a reader associated with the electronically actuated lock system.

15. The methodology according to claim 9, wherein detecting the removal of said tagged medicinal unit includes identifying an altered ID characteristic produced by a frangible component of an RFID tag being ruptured upon access to the unit.

16. The methodology according to claim 9, wherein said closable enclosure is mounted on a mobile EMS vehicle and the capture of wasting data occurs during the course of mobile EMS operations.

17. The methodology according to claim 16, further including uploading the captured wasting data to a central server over a communications network.

18. Methodology for documenting controlled substance wasting at a secure storage vault, comprising:
providing a closable enclosure with an electronically actuated lock system for selectively allowing and inhibiting access to said closable enclosure;
providing a plurality of medicinal units to be received within said closable enclosure;
validating credentials of a first user to unlock said closable enclosure via the lock system;
detecting the removal of at least one specific tagged medicinal unit from said closable enclosure; and
initiating an automated wasting documentation sequence via a user interface associated with said enclosure to capture wasting data related to the specific medicinal unit detected as removed if all contents of the specific medicinal unit are not administered to a patient, wherein the mandatory wasting documentation sequence requires the input of:
(i) identification of a first user performing a wasting process;
(ii) identification of a separate second user witnessing said wasting process;
(iii) a value representing an amount of the controlled substance administered;
(iv) a value representing an amount of the controlled substance wasted; and
(v) a selection of a reason for the wasting of said controlled substance.

19. Methodology according to claim 18, wherein:
said closable enclosure has a securable interior portion;
each respective unit of the plurality of medicinal units received within said securable interior portion is associated with a respective tamper-evident RFID tag having an ID characteristic; and
said methodology further includes providing an RFID reading system associated with said enclosure and adapted for identifying said medicinal units by reading said ID characteristics; and
wherein detecting removal of a specific medicinal unit is detected via a change in the status of its associated RFID tag.
